(19) United States
(12) Patent Application Publication
(10) Pub. No.: US 2015/0086251 A1
(43) Pub. Date: Mar. 26, 2015

(54) IMAGE FORMING APPARATUS

(71) Applicant: CANON KABUSHIKI KAISHA, Tokyo (JP)

(72) Inventor: Hiroki Takayanagi, Abiko-shi (JP)

(21) Appl. No.: 14/492,579

(22) Filed: Sep. 22, 2014

(30) Foreign Application Priority Data
Sep. 24, 2013 (JP) 2013-196965

(51) Int. Cl. G03G 15/20

(52) U.S. Cl. CPC G03G 15/2028
USPC 399/322; 399/329

(57) ABSTRACT

An image forming apparatus includes: a toner image forming unit; an intermediary transfer belt; a transfer roller; a fixing device including a first belt stretched by a first roller and a first stretching roller and a second belt stretched by a second roller and a second stretching roller spaced from the first stretching roller; and a guiding member. The guiding member is provided downstream of a transfer portion and upstream of the fixing device with respect to a recording material feeding direction. The guiding member is disposed, at a downstream end thereof, in a nip side relative to an upstream common tangential line of the first and second stretching rollers with respect to the feeding direction and is disposed at a position closer to the second stretching roller than to the first stretching roller on the upstream common tangential line. The guiding member includes a flat plate-like electrode.

### FIELD OF THE INVENTION AND RELATED ART

The present invention relates to an image forming apparatus for forming an image on a transfer material (recording material).

The image forming apparatus for forming an image on a transfer material (recording material).

The image forming apparatus in which a toner image carried on an intermediary transfer member is transferred onto the transfer material at a transfer portion and then is fixed on the transfer material by heating and pressing the transfer material, on which the toner image transferred, by a fixing device has been used widely.

In Japanese Laid-Open Patent Application (JP-A) 2010-85968, a fixing device in which a nip for the transfer material is formed between a belt, stretched by a plurality of rollers and heated to a high temperature, and a pressing roller having an elastic layer is shown. Further, a guiding member which is electroconductive member is provided at a position adjacent to the pressing roller, and the transfer material is delivered onto the pressing roller along the guiding member and then is fixed to the nip.

In JP-A 2011-81079, a fixing device of a so-called twin-belt type in which a nip for the transfer material is formed between a first belt, stretched by a plurality of rollers and heated to a high temperature, and a second belt stretched by another plurality of rollers is shown. In the fixing device of the twin-belt type, in generated, a guiding member which is electroconductive member is provided at a position adjacent to the second belt, and the transfer material is delivered onto the second belt along the guiding member and then is fixed to the nip.

In the image forming apparatus in which the fixing device of the twin-belt type is disposed downstream of the transfer portion constituted by an intermediary transfer belt between the first belt and the second belt, it turned out that behavior of a leading end of the transfer material becomes unstable. It turned out that a position where the leading end of the transfer material is delivered is changed frontward and rearward depending on a charged state of the transfer material passing through the transfer portion and a charged state of the first belt and the second belt. In an extreme case, it turned out that the toner image is disturbed by contact of a toner-image-carrying-surface of the transfer material with the first belt in a side upstream of the nip with respect to a transfer material feeding direction.

### SUMMARY OF THE INVENTION

According to an aspect of the present invention, there is provided an image forming apparatus comprising: a toner image forming unit; an intermediary transfer belt for forming a toner image by the toner image forming unit; a transfer roller for transferring the toner image, formed on the intermediary transfer belt, onto a recording material at a transfer portion; a fixing device for fixing the toner image on the recording material by feeding, heating and pressing the recording material carrying the toner image at a nip formed by contact of a first belt and a second belt, wherein the first belt is provided at a position where a toner-image-carrying-surface of the recording material contacts the first belt and is stretched by a first roller forming the nip and a first stretching roller provided upstream of the first roller with respect to a recording material feeding direction, and the second belt is stretched by a second roller forming the nip and a second stretching roller provided upstream of the second roller with respect to the recording material feeding direction while being spaced from the first stretching roller with an interval; and a guiding member for guiding the recording material into the nip of the fixing device, wherein the guiding member is provided downstream of the transfer position and upstream of the fixing device with respect to the recording material feeding direction while extending along a recording material feeding path, wherein the guiding member is disposed, at a downstream end thereof, in a nip side relative to an upstream common tangential line of the first and second stretching rollers with respect to the recording material feeding direction and is disposed at a position closer to the second stretching roller than to the first stretching roller on the upstream common tangential line, and wherein the guiding member includes a flat plate-like electrode.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of a fixing device.

In FIG. 3, (a) and (b) are illustrations of charging of a transfer material at a secondary-transfer portion.

FIG. 4 is an illustration of charge of the transfer material by separation discharge.

FIG. 5 is an illustration of a structure of a fixing device in Comparison Example 1.

In FIG. 6, (a) and (b) are illustrations each showing a relationship between a charged state and a transfer material leading end.

FIG. 7 is an illustration of an arrangement of a fixing (device) entrance guide.

FIG. 8 is a perspective view of the fixing entrance guide in Embodiment 1.

FIG. 9 is a perspective view of a fixing entrance guide in Embodiment 2.

FIG. 10 is an illustration of arrangement of a fixing device in Comparison Example 2.

### DESCRIPTION OF THE EMBODIMENTS

Embodiments of the present invention will be described specifically with reference to the drawings. (Image forming apparatus)

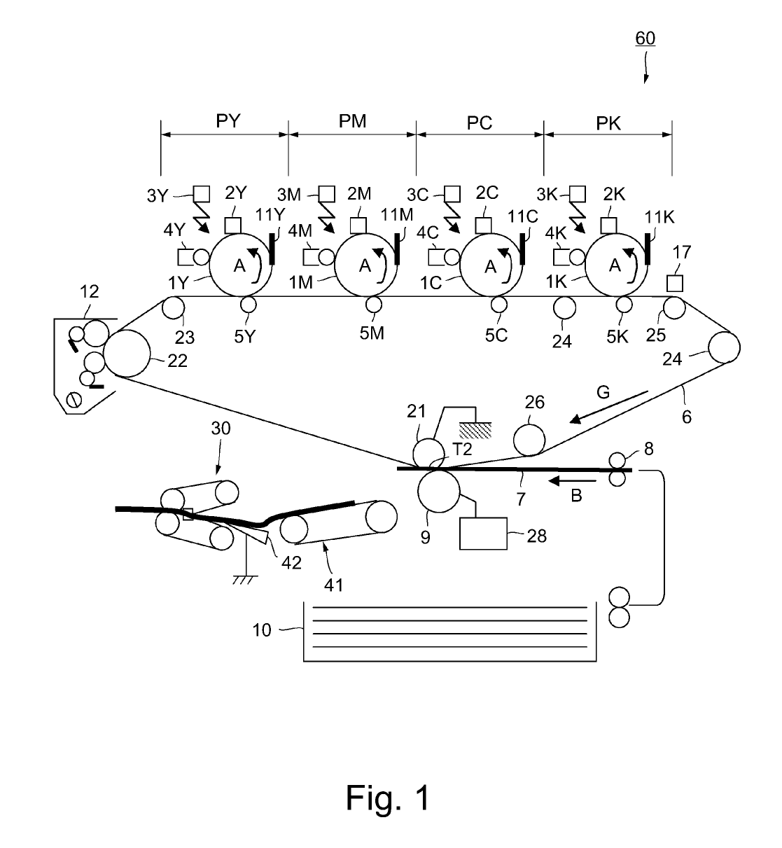

FIG. 1 is an illustration of a structure of an image forming apparatus 60. As shown in FIG. 1, the image forming apparatus 60 is an intermediary transfer type full color printer of a tandem type in which image forming portions PY, PM, PC and PK for yellow, magenta, cyan and black, respectively, are arranged along an intermediary transfer belt 6.

At the image forming portion PY, a yellow toner image is formed on a photosensitive drum 1Y and then is primary-transferred onto the intermediary transfer belt 6. At the image forming portion PM, a magenta toner image is formed on a photosensitive drum 1M and then is primary-transferred onto the intermediary transfer belt 6. At the image forming portions PC and PK, cyan and black toner images are formed on photosensitive drums 10 and 1K, respectively, and then are primary-transferred onto the intermediary transfer belt 6.

A transfer material (recording material) 7 is taken out from a cassette 10 one by one, and then is in a stand-by state at a registration roller pair 8. The transfer material 7 is fed to a secondary transfer portion T2 by the registration roller pair 8 by being timed to the toner images on the intermediary transfer belt, and then the four color toner images are secondary-transferred onto the transfer material 7 is fed to a fixing device 30, and then is pressed and heated by the fixing device 30, and then is, after being subjected to fixing of images thereon, discharged to an outside of the image forming apparatus.

### (Image Forming Portion)

As shown in FIG. 1, the image forming portions PY, PM, PC and PK have the substantially same constitution except that colors of toners used in developing devices are yellow, magenta, cyan and black, respectively, which are different from each other. In the following, the image forming portion PY for yellow is described, and substantially redundant explanation about the image forming portions PM, PC and PK will be omitted.

The image forming portion PY includes, at a periphery of the photosensitive drum 1Y, a corona charger 2Y, an exposure device 3Y, a developing device 4Y, a transfer roller 5Y and drum cleaning device 11Y. The photosensitive drum 11 is prepared by forming a photosensitive layer of an OPC on an outer peripheral surface of an aluminum cylinder, and rotates in an arrow A direction. The charging roller 12 electrically charges a surface of the photosensitive drum 1Y to a uniform negative dark portion potential VD by irradiating the surface with charged particles generated by corona discharge.

The exposure device 3Y scans the surface of the photosensitive drum 1Y with a laser beam which is ON/OFF-modulated based on an image signal obtained by developing an image on a scanning line to lower an exposed portion potential to a light portion potential VL, so that an electrostatic image depending on the image is formed on the surface of the photosensitive drum 1Y.

The developing device 14 develops the electrostatic image into the toner image by carrying a developer, containing a toner and a carrier, on a developing sleeve in an erected state of a chain of the developer after the developer is stirred to charge the toner to negative and the carrier to positive. The toner is moved onto the photosensitive drum 1Y by applying an oscillating voltage, in the form of a negative DC voltage Vdc biased with an AC voltage, to the developing sleeve.

The transfer roller 5Y presses an inner surface of the intermediary transfer belt 6 to form a toner image transfer portion between the photosensitive drum 1Y and the intermediary transfer belt 6. By applying a positive DC voltage to the transfer roller 5Y, the toner image carried on the photosensitive drum 1Y is transferred onto the intermediary transfer belt 6.

The transfer roller 5Y is formed to have an outer diameter of 15-20 mm by providing an elastic layer of an ion-conductive foam rubber on a peripheral surface of a core metal of a stainless steel round bar. In a normal-temperature and normal-humidity environment (N/N: 23 C, 50% RH), a resistance value under application of a voltage of 2 kV is 1×10⁵Ω-1×10⁸Ω. By applying a transfer voltage of +1 KV to +5 KV, a transfer current of +15 μA to +70 μA is caused to flow.

### (Intermediary Transfer Belt)

The intermediary transfer belt 6 is supported by being extended around a tension roller 22. a driving roller 24 and an inner secondary-transfer roller 21. The tension roller 22 is urged outwardly by an unshown spring to contact tension of the intermediary transfer belt 6 at a constant level. The driving roller 24 drives the intermediary transfer belt 6, thus rotating the intermediary transfer belt 6 in an arrow G direction at a peripheral speed of 150 mm/sec to 360 mm/sec.

The intermediary transfer belt 6 is, in the normal-temperature and normal-humidity environment (N/N: 23 C, 50% RH), 1×10⁸ Ω·cm to 1×10¹⁴ Ω·cm in a volume resistivity, 60° to 85° in MD1 hardness, and 0.2 to 0.6 in coefficient of static friction.

The intermediary transfer belt 6 is prepared by forming an elastic layer of 0.1 mm to 0.5 mm in thickness on a base layer of 0.05 mm to 0.15 mm in thickness and then by providing a second layer of 0.001 mm to 0.020 mm in thickness at a surface thereof. The base layer is prepared by incorporating carbon black as an anti-static agent in an appropriate amount in a resin material, such as polyimide or polycarbonate, or various rubbers or the like. The elastic layer is prepared by incorporating carbon black as the anti-static agent in an appropriate amount in various rubbers, such as CR rubber or urethane rubber, or the like. The surface layer is formed of a resin material, such as a fluorine-containing resin, having a good parting property.

### (Secondary Transfer Portion)

The secondary-transfer roller 9 contacts the intermediary transfer belt 6 supported by the inner secondary-transfer roller 21 to form the secondary-transfer portion T2 for the toner image to be transferred onto the transfer material. The secondary-transfer roller 9 is a transfer roller including an elastic layer as a surface layer in which fine cells of a foam cell is formed so that the number thereof is 5 cells or more in a length of 2 mm. The intermediary transfer belt 6 has the elastic layer. The secondary-transfer roller 9 has the elastic layer in which the number of cells of the foam cell is 5 cells or more per 2 mm in length.

The secondary-transfer roller 9 is prepared by forming the elastic layer of an ion-conductive foam rubber on an outer peripheral surface of a core metal which is a stainless steel round bar so as to have an outer diameter of 20 mm to 25 mm. In the normal-temperature and normal-humidity (N/N: 23° C., 50% RH), the resistance value under application of a voltage of 2 KV is 1×10⁵Ω to 1×10⁸Ω. The inner secondary-transfer roller 21 is prepared by forming the elastic layer of an electron-conductive rubber on an outer peripheral surface of a core metal which is a stainless steel round bar so as to have an outer diameter of 20 mm to 22 mm. In the normal-temperature and normal-humidity (N/N: 23° C., 50% RH), the resistance value under application of a voltage of 50 V is 1×10⁵Ω to 1×10⁸Ω.

The inner secondary-transfer roller 21 is connected to a ground potential. To the transfer roller 9, a transfer voltage, which is opposite in polarity to the toner image and which is subjected to a constant-voltage contact, is applied. For example, by applying the transfer voltage of +1 KV to +7 KV, a transfer current of +15 μA to +100 μA is caused to flow. At the secondary-transfer portion T2 which is an example of a transfer portion, the intermediary transfer belt 6 and the secondary-transfer roller 9 sandwich the transfer material therebetween, so that the toner image is transferred onto the transfer material.

### (Feeding Device Before Fixing)

A feeding device 41 before fixing feeds the transfer material 7, to the fixing device 30, on which the toner image is transferred at the secondary-transfer portion T2. The feeding device 41 places and feeds the transfer material 7 on a feeding belt formed of a rubber material such as EPDM in a width of 100 mm to 110 mm and a thickness of 1 mm to 3 mm at a central portion with respect to a widthwise direction. The feeding belt is provided with many holes each having a diameter of 3 mm to 7 mm, and is sucked from an inside thereof by an unshown fan, whereby a carrying force of the transfer material 7 by the feeding belt is enhanced.

### (Belt Cleaning Device)

The belt cleaning device 12 electrostatically collects a transfer residual toner on the intermediary transfer belt 6 by using a fur brush rotating counterdirectionally to the intermediary transfer belt 6. The transfer residual toner moved to a metal roller rotating in the same direction in contact with the fur brush is scraped off by a cleaning blade contacting the metal roller.

The cleaning blade is formed of urethane rubber in a thickness of 1.6 mm to 2.2 mm, and is 70° to 78° in IRHD hardness in the normal-temperature and normal-humidity environment. The fur brush is 2 denier to 15 denier in fiber thickness, 21 F/mm² to 310 F/mm² in density, 3 mm to 7 mm in fiber length, 8 mm to 17 mm in core metal diameter, 11 mm to 24 mm in outer diameter, and 1×10⁵Ω to 1×10⁸Ω in resistance under application of the voltage of 100 V in the normal-temperature and normal-humidity environment.

### Embodiment 1

### Fixing Device

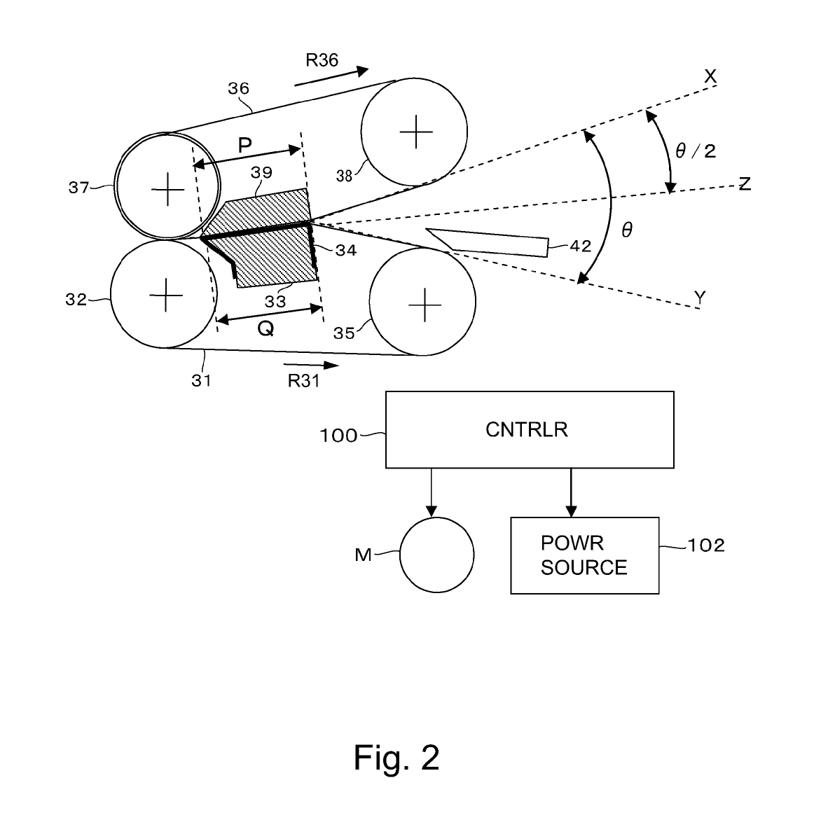

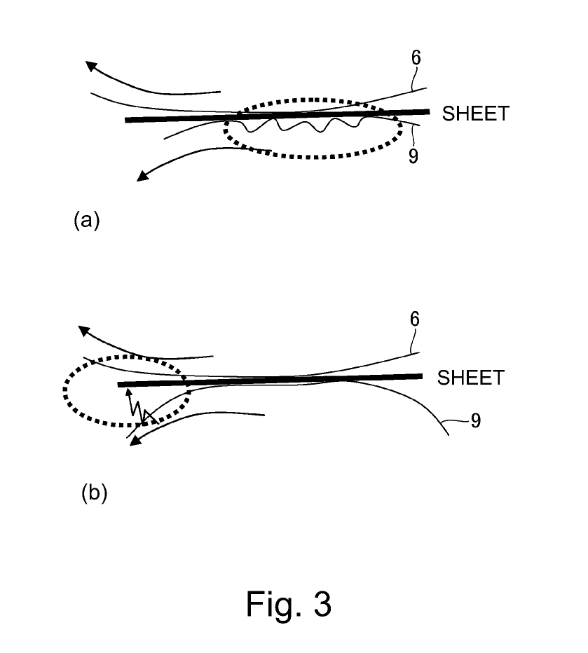

FIG. 2 is an illustration of a structure of the fixing device 30. As shown in FIG. 2, the fixing device 30 in an image heating apparatus of a twin-belt unit nip type in which a nip for the transfer material 7 is formed by contact between a fixing belt 36 and a pressing belt 31.

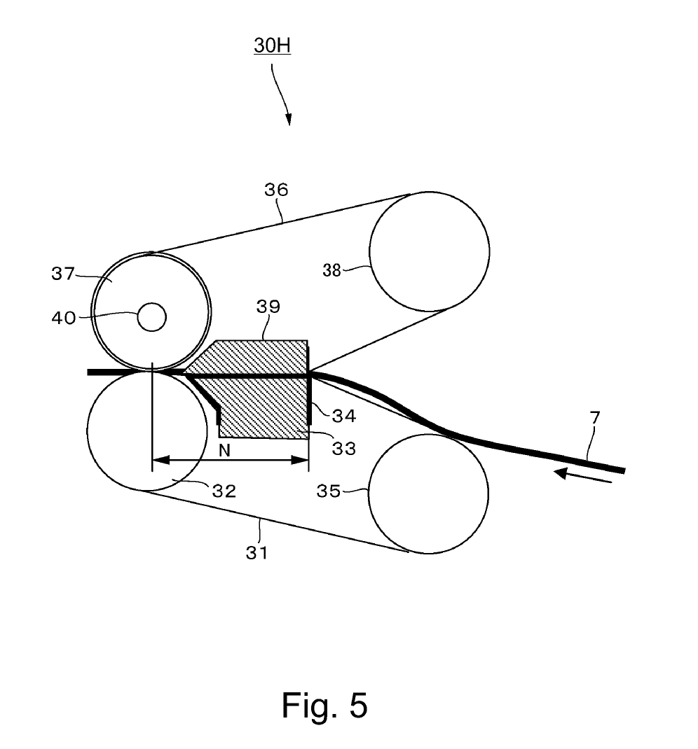

The pressing belt 31 contacts a lower surface of the fixing belt 36 to form a nip N (FIG. 5). A pressing roller 36 urges the fixing belt 36 via the pressing belt 31 at a predetermined urging force.

A controller 100 actuates a driving mechanism M containing a motor and a gear train at predetermined control timing, thus rotating the fixing belt 36 in an arrow R36 direction at a predetermined peripheral speed. When the fixing belt 36 is rotated, by a frictional force at the nip, the pressing belt 31 is rotated by the fixing belt 36 in an arrow R31 direction at the substantially same peripheral speed as the fixing belt 36. When the pressing belt 31 is rotated, inside the pressing belt 31, a tension roller 35 and a pressing roller 32 are rotated by the pressing belt 31.

On a center line inside the fixing roller 37, an unshown halogen heater is provided, and the fixing roller 37 is heated from an inside by generation of the halogen heater. An unshown temperature sensor is provided in contact with the fixing belt 36.

The controller 100 controls electric power, supplied from a power source portion 102 to the halogen heater, on the basis of an output of the temperature sensor, so that a surface temperature of the fixing belt 36 is maintained at a predetermined target temperature. The controller 100 starts supply of the electric power to the halogen heater, thereby to increase the surface temperature of the fixing belt 36 to the predetermined target temperature.

When the surface temperature of the fixing belt 36 increases up to the predetermined target temperature, the transfer material 7 on which the toner image is transferred is introduced from the side of the tension rollers 35 and 38 into the fixing device 30 with the toner image carrying surface thereof upward. The transfer material 7 is placed on the pressing belt 31 and then is sent into the nip. The transfer material 7 is nipped and fed through the nip in close contact with the fixing belt 36 at the toner image carrying surface thereof. In a process of the nip feeding, the toner image is heated and pressed, so that the image for fixing is fixed. The transfer material 7 passed through the nip N is successively separated from the surface of the fixing belt 36 and then is discharged from the fixing device 30.

A pressure distribution along the transfer material feeding direction of the nip N is highest in a downstream region where the pressing roller 32 urges the fixing belt 36. The pressing roller 32 enters the elastic layer of the fixing belt 36 via the pressing belt 31, thus depressing the elastic layer. For that reason, the transfer material 7 passing through the nip N successively separates from the surface of the fixing belt 36 at an entrance of the nip N.

Accordingly, the fixing device 30 which is an example of the fixing device heats the transfer material 7 at the nip N between the fixing belt 36 which is an example of a first belt and the pressing belt 31 which is an example of a second belt, so that the toner image is fixed on the transfer material 7. The tension roller 38 which is an example of first upstream roller stretches the fixing belt 36 in a side upstream of the nip N with respect to the transfer material feeding direction. The tension roller 35 which is an example of a second upstream roller stretches the pressing belt 31 at a position spaced from the tension roller 38 provided upstream of the nip N with respect to the transfer material feeding direction so as to form an opposing interval between the fixing belt 36 and the pressing belt 31.

A fixing pad 39 which is an example of a first pressing member contacts an inner surface of the fixing belt 36 in a side downstream of the tension roller 38 with respect to the transfer material feeding direction. A pressing pad 33 which is an example of a second pressing member presses the fixing belt 36 and the pressing belt 31 between the pressing pad 33 and the fixing pad 36 to form the nip N.

### (Fixing Belt Portion)

The fixing belt 36 in an endless and flexible composite belt stretched and provided between the fixing roller 37 and the tension roller 38. The fixing belt 36 is prepared by laminating an elastic layer of 300 μm to 500 μm in thickness on, as a base layer, a flexible metal belt of 50 mm to 70 mm in inner diameter and 55 μm to 75 μm in thickness, and then by coating an outer peripheral surface of the elastic layer with a parting layer of 30 μm to 50 μm in thickness. The elastic layer is formed of a silicone rubber of 30° in JIS-A hardness and 1.0 W/mK in thermal conductivity. The parting layer is formed of a fluorine-containing resin material (PFA, PTFE or the like).

The fixing roller 37 is prepared by bonding a silicone rubber layer of 30° in JIS-A hardness, 1.0 W/mK in thermal conductivity and 0.3 mm to 0.7 mm in thickness on a metal roller of a stainless steel pipe of 18 mm to 25 mm in outer diameter, so that a roller of 18.6 mm to 26.4 mm in diameter is obtained. The fixing roller 37 is rotatably supported at end portions by bearings provided on side plates of a casing of the fixing device 30.

The tension roller 38 is disposed upstream of the fixing roller 37 with respect to the transfer material feeding direction. The tension roller 38 is urged at the end portions by an unshown coil spring in a direction of applying tension to the fixing belt 36. The tension roller 38 is a roller using a stainless steel circular pipe of 18 mm to 25 mm in outer diameter. The tension roller 38 is rotatably supported at end portions by bearings provided on the side plates of the casing of the fixing device 30. Inside the fixing device 30, a heat pipe for uniforming a longitudinal thermal distribution may also be provided.

The fixing pad 39 is provided adjacently to the fixing roller 37 inside the fixing belt 36, and is constituted by metal such as stainless steel or aluminum. The fixing pad 36 is 15 mm to 19 mm in length P along the transfer material feeding direction, and is 350 mm in length with respect to a transfer material widthwise direction perpendicular to the transfer material feeding direction.

### (Pressing Belt Portion)

The pressing belt 31 is an endless and flexible composite belt stretched and provided between the tension roller 35 and the pressing roller 32. The pressing belt 31 uses, as a base layer, a flexible metal belt of 50 mm to 70 mm in inner diameter and 40 μm to 60 μm in thickness, and is prepared by coating an outer peripheral surface of the base layer with a parting layer which is 30 μm to 50 μm in thickness, and is formed of a fluorine-containing resin material (PFA, PTFE or the like).

The pressing roller 32 is a rigid roller which has a low sliding property and uses an iron-alloy-made circular pipe of 20 mm in outer diameter, 16 mm in inner diameter and 2 mm in thickness. The pressing roller 32 is rotatably supported at end portions by bearings provided on side plates of a casing of the fixing device 30.

The tension roller 35 is disposed upstream of the pressing roller 32 with respect to the transfer material feeding direction. The tension roller 35 is urged at the end portions by an unshown coil spring in a direction of applying tension to the pressing belt 31. The tension roller 35 is a rigid roller using an iron-alloy-made circular pipe of 18 mm to 25 mm in outer diameter 14 mm to 21 mm in inner diameter and 2 mm in thickness. The tension roller 35 is rotatably supported at end portions by bearings provided on the side plates of the casing of the fixing device 30. The tension roller 35 may also be provided with a silicone sponge layer at a surface thereof in order to decrease heat conduction to the pressing belt 31 by decreasing thermal conductivity.

The pressing pad 33 is provided inside the pressing belt 31 and adjacently to the pressing roller 32, and urges the fixing belt 36 from an inner surface of the pressing belt 31. The pressing pad 33 is prepared by bonding, to a stainless steel plate, a silicone rubber elastic layer of 20° in JIS-A hardness, 0.8 W/mK in thermal conductivity and 4 mm in thickness. A slidable sheet 34 is provided while covering an outer peripheral surface of the pressing pad 33, and has a parting layer, of a fluorine-containing resin material (PI, PFA or the like), at a surface thereof, thus alleviating a sliding resistance with an inner surface of the pressing belt 31. The pressing pad 33 is 9 mm to 14 mm in length Q, smaller than the length P of the fixing pad 36, along the transfer material feeding direction, and is 350 mm in length with respect to a transfer material widthwise direction perpendicular to the transfer material feeding direction.

A region where the pressing belt 31 is supported by the pressing pad 33 and the pressing roller 32 contacts the fixing belt 36, thus forming the nip N for the transfer material. The pressing roller 32 and the pressing pad 33 are pressed by an under pressing mechanism at a total load of 784 N (80 kgf) in a direction toward the fixing belt 36.

### (Variation of Charged State of Transfer Material)

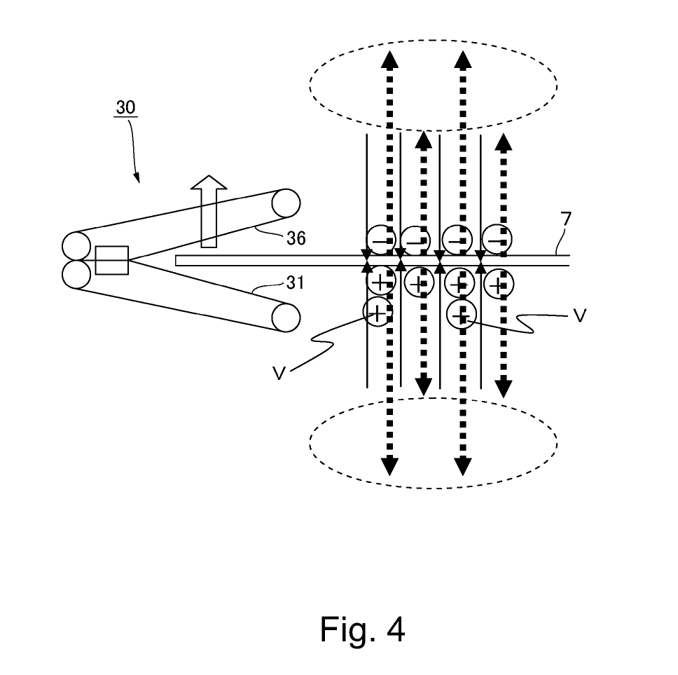

In FIG. 3, (a) and (b) are illustrations of charging of the transfer material at the secondary-transfer portion. FIG. 4 is an illustration of charging of the transfer material by separation discharge.

In recent years, a demand for image quality improvement of an output image becomes high, and therefore in order to satisfactorily carry out the secondary-transfer of the toner image at the secondary-transfer portion T2, there is a need to alleviate electric discharge in the nip of the secondary-transfer portion T2. For that reason, the intermediary transfer belt 6 is provided with the elastic layer, and fine cells are used for the foam layer as the elastic layer of the secondary-transfer roller 9, so that a close contact property between the transfer material 7 and the intermediary transfer belt 6 at the secondary-transfer portion T2 is enhanced.

However, it turned out that when the close contact property between the transfer material 7 and the secondary-transfer roller 9 is enhanced, a degree of fluctuation of a charge amount of the transfer material 7 after passing through the secondary-transfer portion T2 becomes large and thus behavior of a leading end of the transfer material becomes unstable when the transfer material is fed to the fixing device 30.

As shown in (a) of FIG. 3, in the case where the close contact property between the transfer material 7 and the secondary-transfer roller 9 at the secondary-transfer portion T2 is not high, the electric discharge generates at the surface of the secondary-transfer roller 9, so that positive charges are accumulated on the back surface of the transfer material. However, negative charges are accumulated at the front surface of the transfer material through the separated discharge when the transfer material 7 is separated from the intermediary transfer belt 6, and therefore on the transfer material 7 passed through the secondary-transfer portion T2, the electric charges on the front and back surfaces of the transfer material 7 are macroscopically canceled with each other, and thus an apparent charge amount becomes small. For that reason, electric attraction acting between the transfer material 7 and the fixing belt 36 when the transfer material 7 is fed to the fixing device 30 is not so large. An example in which the close contact property between the transfer material 7 and the secondary-transfer roller 9 is the case where in the elastic layer of the secondary-transfer roller 9, the foam cell having 3 to 4 cells per 2 mm in length is used.

On the other hand, shown in (b) of FIG. 3, in the case where the close contact property between the transfer material 7 and the secondary-transfer roller 9 at the secondary-transfer portion T2 is high, the electric discharge less generate at the surface of the secondary-transfer roller 9, so that positive charges are not readily accumulated on the back surface of the transfer material. However, negative charges are similarly accumulated at the front surface of the transfer material through the separated discharge when the transfer material 7 is separated from the intermediary transfer belt 6, and therefore the transfer material 7 passed through the secondary-transfer portion T2 is influenced by the negative electric charges at the front surface of the transfer material 7 and thus has a negatively large charge amount. For that reason, electric attraction strongly acts between the transfer material 7 and the fixing belt 36 when the transfer material 7 is fed to the fixing device 30, so that the behavior of the leading end of the transfer material 7 to be fed to the nip N becomes unstable. An example in which the close contact property between the transfer material 7 and the secondary-transfer roller 9 is the case where in the elastic layer of the secondary-transfer roller 9, the foam cell having 5 cells or more per 2 mm in length is used.

As shown in FIG. 4, outside the nip of the secondary-transfer portion T2, similarly as in the nip, the positive electric charges are provided from the secondary-transfer roller 9, and the negative electric charges are provided from the intermediary transfer belt 6. However, the transfer material 7 moves away from the inner secondary-transfer roller 21 which is grounded, and therefore equivalent electric charges opposite in polarity to the electric charges provided from the secondary-transfer roller 9 by the electric discharge cannot be stably provided, so that the electric charges on the front and back surfaces of the transfer material 7 are liable to be out of balance.

When the electric charges at the front and back surfaces are out of balance, a portion where electric force lines formed by the positive and negative electric charges are not canceled with each other, and as a result, the electric charge amount on the transfer material 7 becomes large, so that an electric field generates outside the transfer material 7. The transfer material 7 large in charge amount is, when the transfer material 7 is guided toward the nip N of the fixing device 30, attracted toward the fixing belt 36 depending on the direction of the electric field, such as the electric field by the contact charging, created by the pressing belt 31 and the fixing belt 36 which are close to each other at an entrance of the nip N.

### Comparison Example 1

FIG. 5 is an illustration of a structure of a fixing device in Comparison Example 1. In FIG. 6, (a) and (b) are illustrations each showing a relationship between a charged state of the transfer material and behavior of the transfer material leading end. In FIG. 6, (a) shows the case where the transfer material is strongly charged, and (b) shows the case where the transfer material is weakly charged.

As shown in FIG. 5, a fixing device 30H in Comparison Example 1 is a fixing device of a twin-belt type in which the nip is formed by bringing the fixing belt 36 and the pressing belt 31 into contact with each other. When the transfer material 7 is delivered to the pressing belt 31 at a remote position in the upstream side of the nip N with respect to the transfer material feeding direction, the transfer material 7 is attracted to the pressing belt 31 in an oblique movement state and thus the behavior of the transfer material 7 becomes unstable. As a result, a phenomenon that the transfer material 7 after passing through the nip N causes creases generated.

As shown in (a) of FIG. 6, in the fixing device 30H is Comparison Example 1, in the case where the transfer material 7 is strongly charged, a phenomenon that behavior of the transfer material 7 becomes unstable by the attraction of the transfer material 7 to the fixing belt 36 in the upstream side of the nip N with respect to the transfer material feeding generated.

As shown in (b) of FIG. 6, in the fixing device 30H in Comparison Example 1, unless the behavior of the transfer material 7 is unstable by the attraction of the transfer material 7 to the fixing belt 36 in the upstream side of the nip N with respect to the transfer material feeding direction, the transfer material 7 after passing through the nip N does not readily cause the creases. An image disturbance phenomenon does not readily generate.

As described above, unstability of the behavior of the transfer material in the upstream side of the nip N generates by electrostatic attraction of the transfer material, charged at the secondary-transfer portion T2, to the fixing belt 36 or the pressing belt 31. In addition, also the fixing belt 36 and the pressing belt 31 build up static electricity by contact with the charged transfer material 7. Triboelectric charge is generated also by contact and friction between the fixing belt 36 and the pressing belt 31 at the nip N. The fixing belt 36 and the pressing belt 31 build up stronger static electricity with a higher rotational speed.

In such a situation, when a portion where the fixing belt 36 and the pressing belt 31 are closely opposed to each other in the upstream side of the nip N exists, the transfer material behavior changes depending on the charged state of each of the belts 36 and 31. As shown in (a) of FIG. 6, the transfer material 7 is electrostatically attracted to the fixing belt 36 in some cases, and as shown in (b) of FIG. 6, the transfer material 7 is not electrostatically attracted to the fixing belt 36 in some cases.

Therefore, in embodiments of the present invention, a fixing (device) entrance guide 42 is caused to enter between opposing surfaces of the pressing belt 31 and the fixing belt 36. The transfer material large in charge amount is electrically attracted to the fixing entrance guide 42, whereby the transfer material is caused to reach the nip N before the transfer material is attracted to the fixing belt 36.

As a result, an improvement in fixing property and prevention of generation of creases by stabilization of the transfer material behavior in front of the nip N are compatibly realized. (Fixing entrance guide in Embodiment 1)

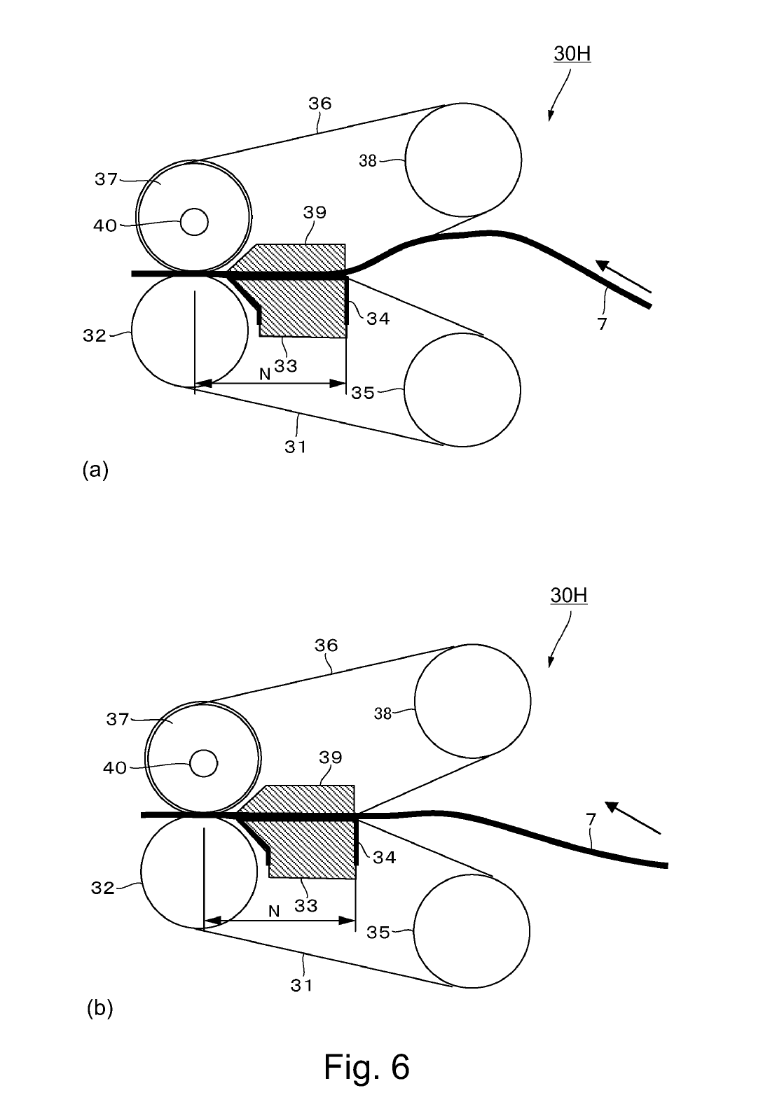

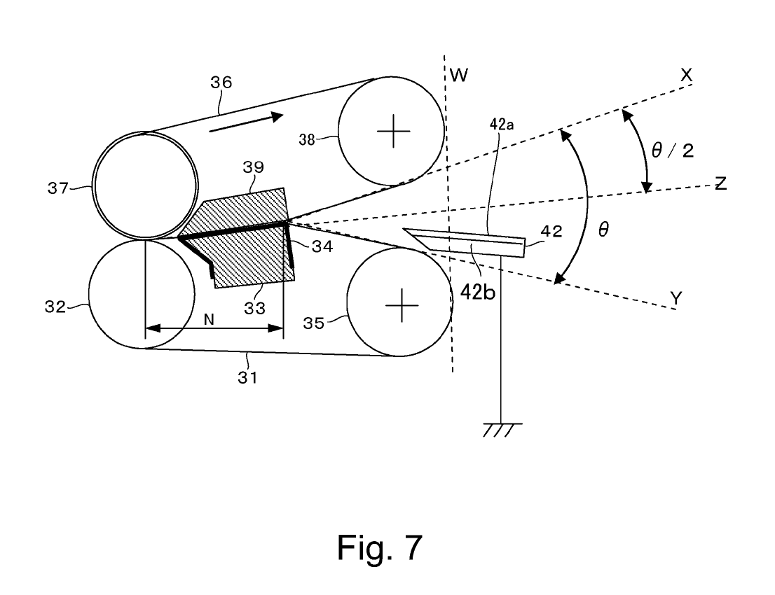

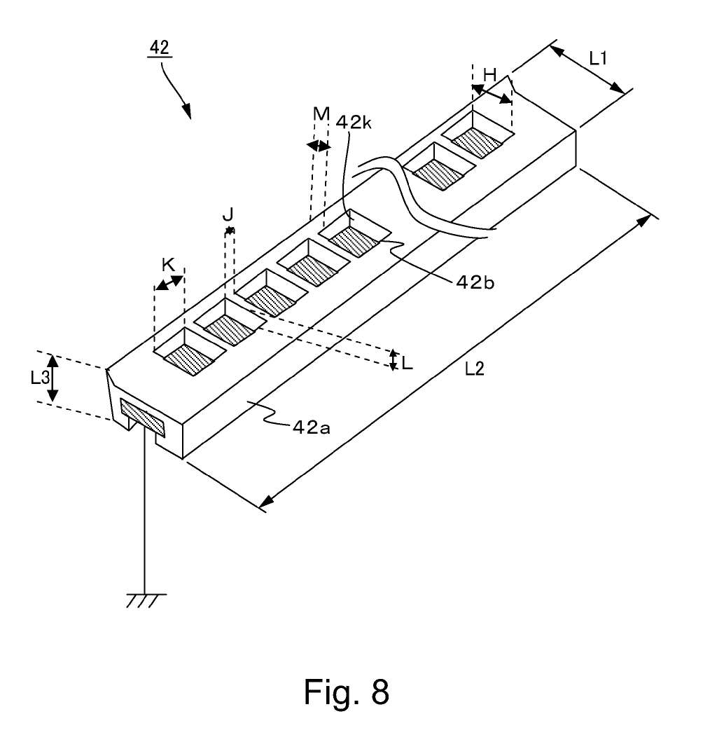

FIG. 7 is an illustration of arrangement of the fixing entrance guide. FIG. 8 is a perspective view of the fixing entrance guide in Embodiment 1. As shown in FIG. 7, a stretching surface of the fixing device 36 between the fixing pad 39 and the tension roller 38 is a belt plane X. A stretching surface of the pressing belt 31 between the pressing pad 33 and the tension roller 35 is a belt plane Y. An example between the belt plane X and the belt plane Y is θ, and a plane with a slope (θ/2) from each of the belt planes X and Y is an intermediary plane Z. The angle θ between the belt planes X and Y is 30° to 60°, and the slope (θ/2) between the intermediary plane Z and the belt plane Y is 15° to 30°. A common tangential line between the tension rollers 38 and 35 is W.

At this time, the fixing entrance guide 42 was disposed so that a part thereof in a leading end side enters toward the nip N relative to the common tangential line W by 7 mm to 13 mm and so that a trailing end side thereof is outside the common tangential line W. The fixing entrance guide 42 was disposed at a position lower than the intermediary plane Z. The fixing entrance guide 42 is disposed between the belt plane Y and the intermediary plane Z. The fixing entrance guide 42 is connected to a ground potential, so that a potential thereof is 0 V.

As shown in FIG. 8, in the fixing entrance guide 42, as a metal plate 42b connected to the ground potential, an aluminum plate of 0.8 mm to 1.5 mm in thickness was used. The fixing entrance guide 42 is 30 mm to 50 mm in length L1 with respect to the transfer material feeding direction, 350 mm in length L2 with respect to a transfer material feeding width direction, and 5 mm to 7 mm in height L3 in the nip N side.

The metal plate 42b is covered with a resin layer 42a formed by arranging a plurality of openings 42k in the feeding width direction. As a material for the resin layer 42a, an insulating material such as PP, PBT, PES or ABS was used. The openings 42k open to a transfer material feeding plane, so that the transfer material and the metal plate 42b are directly opposed to each other, and this electric attraction (force) is caused to act on the transfer material. Each of the openings 42k has a constant opening width H of 10 mm to 30 mm with respect to the transfer material feeding direction in order to ensure an opposing length to the metal plate 42b. An opening width K with respect to the transfer material feeding width direction is 3 mm to 20 mm, but the openings 42k of 3 mm to 7 mm, 11 mm to 15 mm and 18 mm to 20 mm in opening width K may also coexist. Ribs each positioned at an interval between adjacent openings 42k is 1 mm to 3 mm in width J.

### (Effect of Embodiment 1)

In Embodiment 1, the fixing entrance guide 42 which is an example of a guiding member guides the transfer material on which the toner image is transferred at the secondary-transfer portion T2 and introduces the transfer material into the nip N. The fixing entrance guide 42 is formed of an electroconductive material, and is disposed at a position closer to the pressing belt 31 than the fixing belt 36.

The metal plate 42b which is an example of an electrode member is connected to the ground potential and therefore cause the electric attraction to act on both the positively charged transfer material and the negatively charged transfer material.

The resin layer 42a which is an example of a sliding portion slides with the surface, of the transfer material, opposite from the surface on which the toner image is transferred, thus forming a predetermined gap between a transfer material opposing surface of the metal plate 42b and the transfer material. The predetermined gap alleviates a degree of the electric attraction, thus suppressing an increase in movement resistance of the transfer material, oblique movement of the transfer material and jam of a thin transfer material.

The resin layer 42a is formed with a rib-shaped insulating material provided on the metal plate 42b along the transfer material feeding direction. The resin layer 42a is disposed continuously from an outside position of the fixing device 30 in the upstream side with respect to the transfer material feeding direction to a leading end position where the transfer material is guided.

According to the fixing entrance guide 42 in Embodiment 1, the potential of the fixing entrance guide 42 is regulated at the ground potential, and therefore it is possible to electrostatically attract the transfer material 7 to the fixing entrance guide 42 irrespective of the charge polarity and charge amount of the transfer material 7 after passing through the secondary-transfer portion T2. The charged transfer material 7 is electrostatically attracted to the fixing entrance guide 42 while opposing the metal plate 42b connected to the ground potential.

According to Embodiment 1, the potential-regulated fixing entrance guide 42 exists at a height position close to the pressing belt 31, and therefore even when the potential of the transfer material 7 charged at the secondary-transfer portion T2 is high, it is possible to prevent the electrostatic attraction of the transfer material 7 to the fixing belt 36 in front of the nip N. Further, it is possible to alleviate a phenomenon that the transfer material 7 floats for attraction to the fixing belt 36.

For this reason, in the fixing device 30 of the twin-belt type, the degree of the electrostatic attraction of the transfer material 7 to the fixing belt 36 in the neighborhood of the nip N is reduced, so that the transfer material 7 was able to be passed through the nip N after being guided into the nip N in a stable manner. The transfer material 7 stably passes through the nip N, and therefore the transfer material 7 does not readily generate the creases, so that a degree of occurrence of improper printing resulting from the creates was also reduced. It is possible to prevent the occurrence of the creases on the transfer material 7 during the passing of the transfer material 7 through the nip N.

According to Embodiment 1, even in the case where the intermediary transfer belt 6 having the elastic layer and the secondary-transfer roller 9 having the elastic layer containing the fine foam cells are combined, it is possible to stabilize the behavior of the transfer material 7 to be fed into the nip N of the fixing device 30. Even when variations in charge polarity and charge amount of the recording material 7 passing through the secondary-transfer portion T2 are large, it is possible to stably deliver the transfer material 7 to the pressing belt 31 at a position close to the nip N. For this reason, it is possible to realize an improvement in image fixing property by combining the intermediary transfer belt 6 having the elastic layer with the secondary-transfer roller 9 having the elastic layer containing the fine foam cells.

According to Embodiment 1, the metal plate 42b is covered with the resin layer 42a and thus does not directly contact the transfer material 7, and therefore even in the case of the thin transfer material 7 charged to a high potential, there is no liability that the transfer material 7 is electrostatically attracted to the metal plate 42b to cause the jam. It is also possible to avoid the adverse affect on the toner image caused by electric charge transfer and electric discharge between the fixing entrance guide 42 and the transfer material 7.

### Embodiment 2

As shown in FIG. 7, in Embodiment 2, similarly as in Embodiment 1, a fixing device of the twin-belt type in which the fixing belt 36 and the pressing belt 31 which are the flexible endless belts as rotatable two nip-forming members for forming the fixing nip by opposing each other.

### (Fixing Entrance Guide in Embodiment 2)

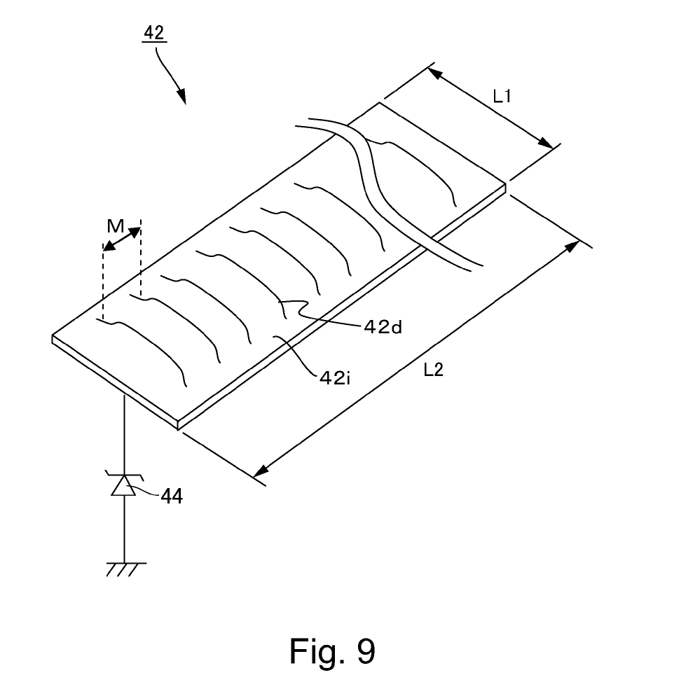

FIG. 9 is a perspective view of a fixing entrance guide in Embodiment 2. As shown in FIG. 9, the fixing entrance guide 42 in Embodiment 2 is formed with a stainless steel plate member of 30 mm to 50 mm in length L1 with respect to the transfer material feeding direction, 350 mm in length L2 with respect to the transfer material feeding width direction, and 0.8 mm to 1.5 mm in thickness.

The fixing entrance guide 42 is regulated in potential so as to ensure the electric attraction to the transfer material 7, and therefore if an electrode surface 42i is a flat surface, an electrostatic attraction force becomes excessively strong, so that there is a possibility that a feeding resistance increases.

For that reason, the fixing entrance guide 42 in Embodiment 2 is provided with ribs 42d which are formed in parallel at a surface thereof by deforming the stainless steel plate member, so that a contact area between the transfer material 7 and the electrode surface 42i is reduced. Each of the ribs 42d is 1 mm to 4 mm in radius of curvature at a crest portion, 1 mm to 2 mm in height, and 3 mm to 20 mm in interval M between adjacent ribs 42d. Incidentally, it is also possible to provide the ribs 42d different in interval M so as to increase a distribution density of the ribs 42d in an edge region of the transfer material 7.

The fixing entrance guide 42 is connected to the ground potential via a varister element 44 having a varister characteristic. As the varister element 44, a varister element having a characteristic such that a potential difference of about 0.7 kV to about 1.5 kV is formed when a current flows was used.

The reason why the fixing entrance guide 42 is grounded via the varister element 44 is that when the transfer material 7 low in resistance value is used in the case where a distance between the secondary-transfer portion T2 and the fixing entrance guide 42 is short, a part of a transfer current at the secondary-transfer portion T2 leaks out into the fixing entrance guide 42. During contact of the transfer material 7, passed through the secondary-transfer portion T2, with the fixing entrance guide 42, the part of the transfer current at the secondary-transfer portion T2 passes through the transfer material 7 and then leaks out into the fixing entrance guide 42. For this reason, a stepped portion of the toner image transfer efficiency at the secondary-transfer portion T2 is generated before and after the contact of the transfer material 7 with the fixing entrance guide 42 and between before and after the transfer material 7 passes through the secondary-transfer portion T2, so that an image quality is lowered. There is a possibility that the transfer current passing through the secondary-transfer portion T2 becomes short and thus causes improper transfer.

In FIG. 2, the ribs 42d which are examples of the sliding portion are ribs formed on the fixing entrance guide 42 of the stainless steel plate member along the transfer material feeding direction. The varister element which is an example of a potential regulating element causes short-circuit at a predetermined voltage, thus regulating the potential of the fixing entrance guide 42. The fixing entrance guide 42 is connected to the ground potential via the varister element 44. The fixing entrance guide 42 is grounded via the varister element 44 having the varister characteristic, so that prevention of the secondary-transfer defect and stabilization of the behavior of the transfer material 7 at the nip N can be compatibly realized.

### Comparison Example 2

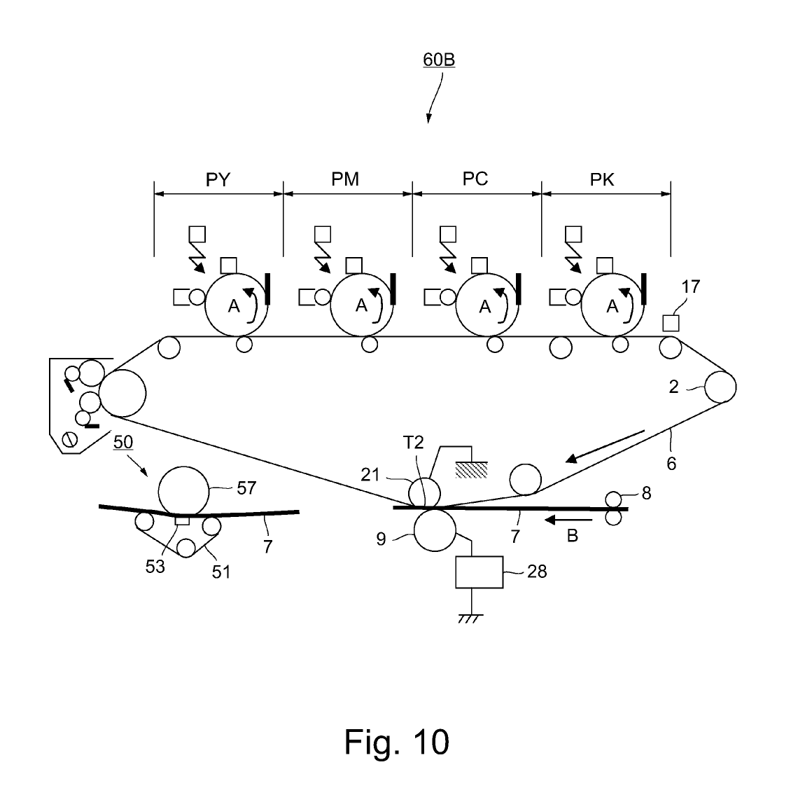

FIG. 10 is an illustration of arrangement of a fixing device in Comparison Example 2.

As shown in FIG. 10, a fixing device 50 in Comparison Example 2 forms a nip N for the transfer material 7 by press-contacting a pressing belt 51 against a fixing roller 57. In the fixing device 50, a region where the fixing roller 57 and the pressing belt 51 oppose each other in the upstream side of the nip N is narrow, and therefore behavior of the transfer material 7 charged at the secondary-transfer portion T2 does not readily become unstable. As a result, there was no generation of a phenomenon that the transfer material 7 after passing through the fixing device 50 caused creases.

### OTHER EMBODIMENTS

The above-described embodiments can also be carried out in the embodiments in which a part or all of constituent elements are replaced with their alternative constituent elements so long as the leading end of the fixing entrance guide is caused to enter the opposing interval between the fixing belt and the pressing belt.

Therefore, the image forming apparatus can be carried out irrespective of one drum type/tandem type. The image forming apparatus can also be carried out irrespective of the number of the photosensitive members, a charging type, a type of formation of the electrostatic image, a transfer type, a fixing type, and the like. In the above-described embodiments, only a principal portion relating to formation/transfer of the toner image was described, but by adding necessary devices, equipment and casing structures and the like, the present invention can be carried out in image forming apparatuses of various uses, such as printers, various printing machines, copying machines, facsimile machines, and multi-function machines.

The present invention can be carried out also with respect to a member other than the secondary-transfer roller having the elastic layer including the foam cell having 5 cells or more per a length of 2 mm.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 196965/2013 filed Sep. 24, 2013, which is hereby incorporated by reference.

What is claimed is:

1. An image forming apparatus comprising:
a toner image forming unit;
an intermediary transfer belt for forming a toner image by said toner image forming unit;
a transfer roller for transferring the toner image, formed on said intermediary transfer belt, onto a recording material at a transfer portion;
a fixing device for fixing the toner image on the recording material by feeding, heating and pressing the recording material carrying the toner image at a nip formed by contact of a first belt and a second belt, wherein the first belt is provided at a position where a toner-image-carrying-surface of the recording material contacts the first belt and is stretched by a first roller forming the nip and a first stretching roller provided upstream of the first roller with respect to a recording material feeding direction, and the second belt is stretched by a second roller forming the nip and a second stretching roller provided upstream of the second roller with respect to the recording material feeding direction while being spaced from the first stretching roller with an interval; and
a guiding member for guiding the recording material into the nip of said fixing device, wherein said guiding member is provided downstream of the transfer position and upstream of said fixing device with respect to the recording material feeding direction while extending along a recording material feeding path, wherein said guiding member is disposed, at a downstream end thereof, in a nip side relative to an upstream common tangential line of the first and second stretching rollers with respect to the recording material feeding direction and is disposed at a position closer to the second stretching roller than to the first stretching roller on the upstream common tangential line, and wherein said guiding member includes a flat plate-like electrode.

2. An image forming apparatus according to claim 1, wherein said guiding member includes a guiding portion contacting a surface opposite from the toner-image-transferred-surface of the recording material, and
wherein the electrode is provided with a predetermined interval from the recording material, to be fed, via the guiding portion.

3. An image forming apparatus according to claim 1, wherein each of the first and second belts is a belt of a composite layer at least including a base layer formed of metal and a coating layer formed of a resin material on the base layer.

4. An image forming apparatus according to claim 1, wherein said transfer roller has an elastic layer including a foam cell having 5 cells or more per a length of 2 mm.

5. An image forming apparatus according to claim 1, wherein said fixing device includes a first pressing member contacting an inner surface of the first belt in a side downstream of the first stretching roller with respect to the recording material feeding direction and includes a second pressing for forming the nip by pressing the first and second belts between the second pressing member and the first pressing member.
